(19) United States
(12) Patent Application Publication
(10) Pub. No.: US 2016/0354741 A1
(43) Pub. Date: Dec. 8, 2016

(54) CUP AND MIXING APPARATUS AND METHODS OF PERFORMING THE SAME

(71) Applicant: Overwatch Development Group, Naperville, IL (US)

(72) Inventors: Ronaldo SANTIAGO, South Elgin, IL (US); Scott Beu, Bolingbrook, IL (US); Dave PATTON, Lisle, IL (US)

(21) Appl. No.: 15/172,990

(22) Filed: Jun. 3, 2016

Related U.S. Application Data
(60) Provisional application No. 62/170,801, filed on Jun. 4, 2015.

(51) Int. Cl. B01F 13/08; B01F 3/08

(52) U.S. Cl. CPC B01F 13/0845; B01F 3/088

(57) ABSTRACT

A liquid mixing unit including a base unit, a magnet in a magnet recess in the base unit, an outer cylinder, an inner cylinder that is sized to fit in a central cavity in the outer cylinder, and a mixing unit in the inner cylinder.

### RELATED APPLICATIONS

This application claims priority to U.S. Provisional Application No. 62/170,801, entitled CUP AND MIXING APPARATUS AND METHODS OF PERFORMING THE SAME, filed on Jun. 4, 2015.

### BACKGROUND OF THE INVENTION

Mixing liquids together to make mixed drinks is very popular worldwide. Over the years, many methods have been developed to mix liquids together in a cup. These methods include spoons, stirrers and other external devices. As the world has become more mobile, the use of external devices to mix liquids in a cup has become more burdensome as external equipment must be carried or located nearby to stir the liquids.

Further, as the majority of stirrers in the market are disposable, the use of external stirrers adds to the every growing world refuse issue. Therefore, a need exists for a self contained stirring device in a cup.

### BRIEF SUMMARY OF THE INVENTION

One embodiment of the present disclosure includes liquid mixing unit including a base unit, a magnet in a magnet recess in the base unit, an outer cylinder, an inner cylinder that is sized to fit in a central cavity in the outer cylinder, and a mixing unit in the inner cylinder.

Another embodiment includes a plurality of O shaped rings between the base unit ad the cylinders.

Another embodiment includes a cap unit covering an open end of the outer cylinder.

Another embodiment includes a pressure relief unit in the cap unit.

Another embodiment includes a ridge on one end of the outer cylinder.

Another embodiment includes a ridge on the inner wall of the base unit that corresponds to the ridge on the outer cylinder when the base unit engages the outer cylinder.

In another embodiment, the O-ring is positioned between the base unit ridge and the outer cylinder ridge.

In another embodiment, the mixing unit is made from a ferrous material.

In another embodiment, the magnet magnetically engages the mixing unit to rotate the mixing unit as the base unit is rotated.

In another embodiment, the base unit includes a rotating portion rotatively coupled to a stationary portion that is affixed to the outer and inner cylinders.

### BRIEF DESCRIPTION OF THE SEVERAL VIEWS OF THE DRAWING

FIG. 1 depicts a break away view of the mixing cup;

FIG. 2 depicts the cup unit of the mixing cup of FIG. 1;

FIG. 3 depicts the mixing unit of the mixing cup of FIG. 1;

FIG. 4 depicts an assembled view of the mixing cup of FIG. 1.

### DETAILED DESCRIPTION OF INVENTION

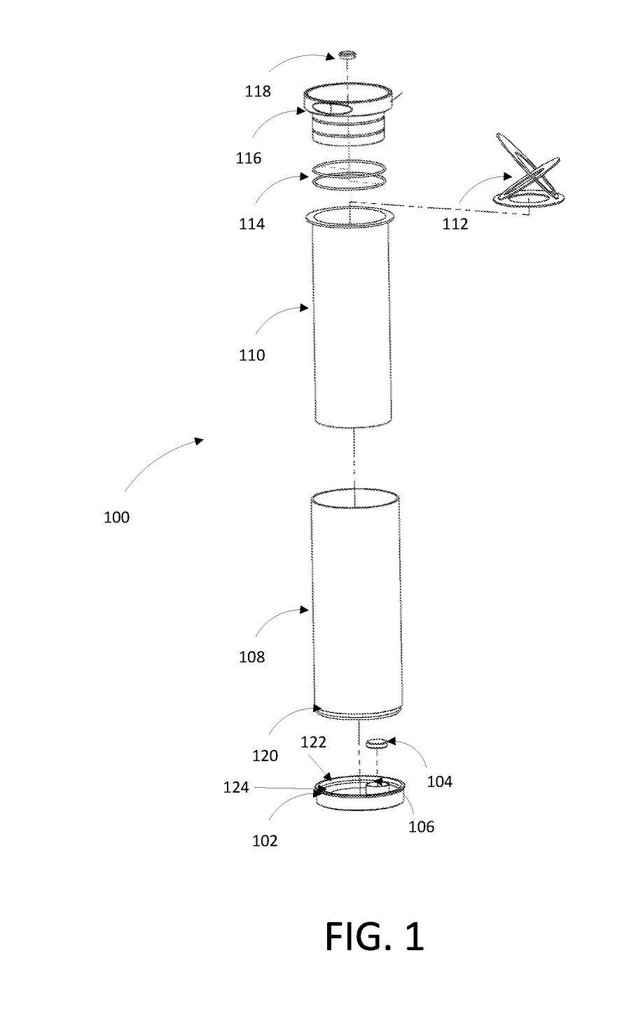

FIG. 1 depicts one embodiment of a liquid mixing unit 100 that is consistent with the present disclosure. The liquid mixing unit 100 includes a base unit 102, a magnet 104 in a magnet recess 106 in the base unit 102, an outer cylinder 108, an inner cylinder 110 that is sized to fit in a central cavity in the outer cylinder 108, a mixing unit 112, a plurality of O shaped rings 114, a cap unit 116 and a pressure relief unit 118. One end of the outer cylinder 108 includes a ridge 120. The ridge 120 is configured to engage a corresponding ridge 122 on the inner wall 124 of the base unit 102 such that the base unit 102 rotates in relation the outer cylinder 108 when the base unit 102 engages the outer cylinder 108. In one embodiment, an O shaped ring is place between the ridge 120 and ridge 122 to form a leak proof seal.

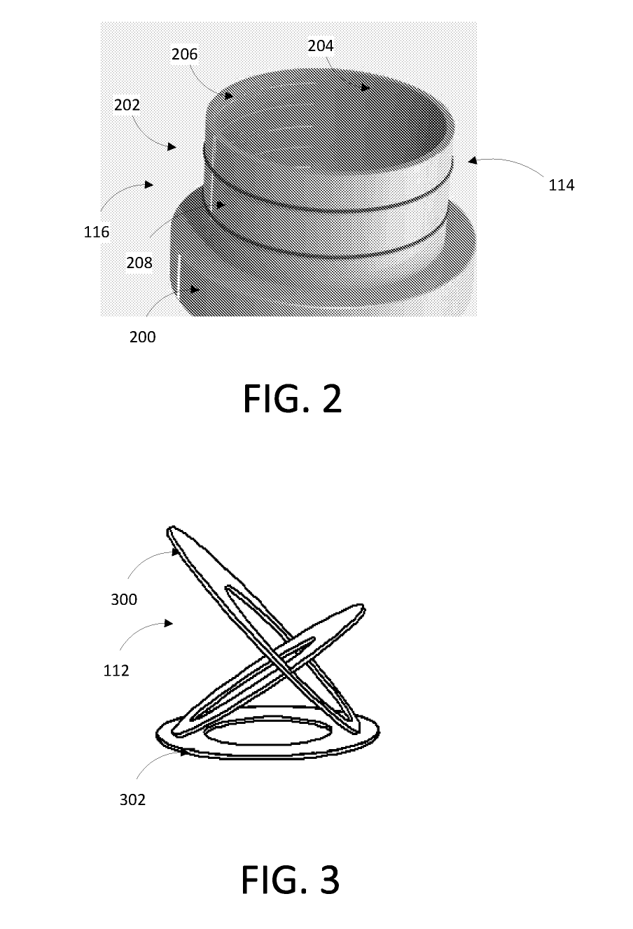

FIG. 2 depicts one embodiment of the cap unit 116. The cap unit 116 includes a base portion 200 and a cup portion 202 extending from the base portion 200. The inner wall 204 of the cup portion 202 include ridges 206 indicating a volume of material in the cavity of the cup portion when filled to the corresponding ridge 206. The cup portion 202 is sized such that an outer diameter of the cup portion 202 is smaller than an inner diameter of the inner cylinder 110. The outer wall 208 of the cup portion 202 includes grooves that are configured to accommodate O shaped rings 114 such that the O shaped rings engage the outer wall 208 of the cup portion 202 and the inner wall of the inner cylinder 110 to form a leak tight seal. By including the ridge portions 206 on the inner wall 204, a user can fill the cup portion 202 with a measured amount of material to mix in the inner cylinder 110.

FIG. 3 depicts one embodiment of the mixing unit 112. The mixing unit 112 includes at least one blade 300 that is attached to a base 302. The blades may be made of any material that is capable of attaching to the base including plastic, metal or composite materials. The mixing blades 300 are angled such that the blade agitate a liquid in the inner cylinder 110 when the mixing unit 112 is rotated. The base 302 of the mixing unit 112 is made of a ferrous material that is configured to magnetically engage the magnet 104 in the base unit 102 when the mixing unit 100 is assembled.

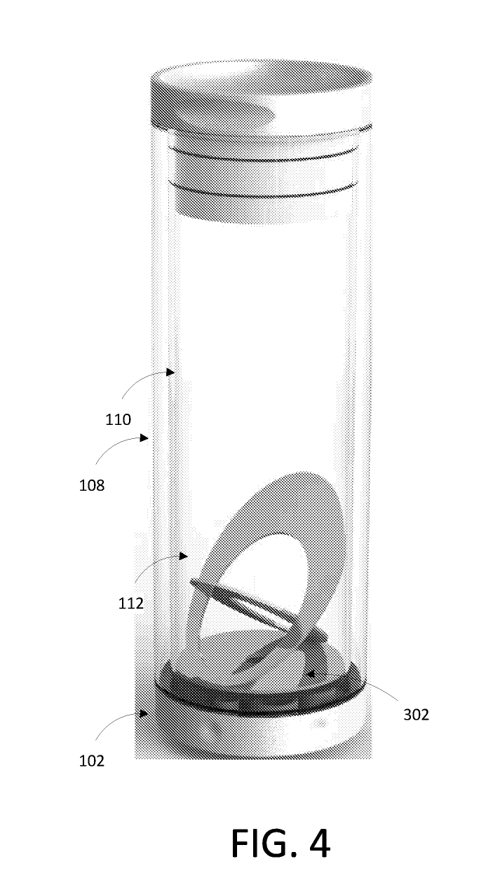

FIG. 4 depicts an assembled liquid mixing unit 100. When assembled, the inner cylinder 110 is place inside the open cavity of the outer cylinder 108 such that a small gap exists between a wall of the outer cylinder 108 and a wall of the inner cylinder 110. The mixing unit 112 is positioned in a cavity in the inner cylinder 110 such that a base portion 400 of the mixing unit 112 rests above the magnet 104 in the base unit 102. In one embodiment, the periphery the base portion 400 of the mixing unit 112 engages a ledge on the inner surface of the wall of the base unit 102. The mixing unit 112 engages the base unit 102 such that the magnet 104 secures the mixing unit 112 to the base unit 102 and rotates the mixing unit when the base unit 102 is rotated. In this way, the mixing unit 102 can be manually manipulated to rotate to mix a liquid in the inner cylinder 110. In one embodiment, the base unit 102 is rotated by placing a finger in an indentation on the back side, i.e. the side opposite the inner cylinder, and rotating the base unit 102 clockwise or counter clockwise. When the base unit 102 is rotated, the magnet 104 attached the base unit 102 rotates the mixing unit 112 such that the mixing unit agitates the liquid in the inner cylinder 110.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims

1. A liquid mixing unit including:
a base unit;
a magnet in a magnet recess in the base unit;
an outer cylinder,
an inner cylinder that is sized to fit in a central cavity in the outer cylinder; and
a mixing unit in the inner cylinder.

2. The liquid mixing unit of claim 1 including a plurality of O shaped rings between the base unit ad the cylinders.

3. The liquid mixing unit of claim 1 including cap unit covering an open end of the outer cylinder.

4. The liquid mixing unit of claim 3 including a pressure relief unit in the cap unit.

5. The liquid mixing unit of claim 1 including a ridge on one end of the outer cylinder.

6. The liquid mixing unit of claim 5 including a ridge on the inner wall of the base unit that corresponds to the ridge on the outer cylinder when the base unit engages the outer cylinder.

7. The liquid mixing unit of claim 6 , wherein the O-ring is positioned between the base unit ridge and the outer cylinder ridge.

8. The liquid mixing unit of claim 1 wherein the mixing unit is made from a ferrous material.

9. The liquid mixing unit of claim 8 wherein the magnet magnetically engages the mixing unit to rotate the mixing unit as the base unit is rotated.

10. The liquid mixing unit of claim 1 wherein the base unit includes a rotating portion rotatively coupled to a stationary portion that is affixed to the outer and inner cylinders.
